(19) United States
(12) Patent Application Publication
(10) Pub. No.: US 2005/0147486 A1
(43) Pub. Date: Jul. 7, 2005

(54) Anti-sabotage and anti-theft device for tire inflating valves

(76) Inventor: Giovanni Barbanti, Casalecchio di Reno (IT)

Correspondence Address: BRADLEY ARANT ROSE & WHITE LLP, 200 CLINTON AVE. WEST, SUITE 900, HUNTSVILLE, AL, 35801, US

(21) Appl. No.: 10/735,466

(22) Filed: Dec. 12, 2003

(51) Int. Cl. F16B 37/08

(52) U.S. Cl. 411/432

(57) ABSTRACT

It is described an anti-sabotage and anti-theft device for tire inflating valves which is realised by a cap (10) with two main elements of FIG. 7 at least, a member (15) with an internal thread and capable of screwing on the end of the valve (9) and the envelope (16) of the same cap, so that the connection between the envelope, on which the screwing and clamping torque is applied, and the member (15) is reached by a click device (FIG. 7 section A-A) in order to allow the transmission of the torque between the envelope and the threaded member in the screwing direction only. So doing, when the clamping of the cap is obtained and a sufficient stopping torque is assured (capable of contrasting the unscrewing torque), it is impossible to unscrew the cap from the valve since the unscrewing torque applied to the envelope is not transmitted to the threaded body.

### BACKGROUND OF THE INVENTION

Most of the terrain and aircraft vehicles moving today use gas-inflated tires with or without tubes. For a proper functioning, a tire has to contain a pre-established gas quantity (usually air, but also different kind of gases), that means that the gas in the tire must reach and maintain a prefixed pressure value in function of a determined reference temperature. When the tire is inflated by introducing a proper gas quantity, said quantity decreases because of natural gas leaks from the tire and, eventually, from other components of the wheel group; this occurs also because of accidental leaks, of more or less high intensity, due to damages and/or punctures. Moreover, the right quantity of gas to be introduced into the tire depends, according to the instructions of the manufacturers of the tires and the vehicles on which said tires are mounted, on the expected using conditions, and in particular on the load and speed. Therefore, more or less frequent interventions are necessary in order to modify or to reset the right quantity of gas inside the tires.

### MAIN FEATURES OF THE INVENTION

The anti-sabotage and anti-theft device for inflating valves of the tires comprises:
a cap with an internally threaded body screwing on an inflating valve of tire;
an envelope connected to the internally threaded body through a free tripper allowing the screwing only and not the unscrewing of the cap, the envelope preventing to directly access to the threaded body,
the access occurring only in a pre-established zone of the threaded body, while the unscrewing of the threading body occurring through a tool acting on said zone.

In a first embodiment the free tripper presents a radial development.

In a second embodiment the free tripper presents an axial development.

An element is provided between the threaded body and the threaded end of the tube of the valve; the element generates an unscrewing couple, which is higher than the one due to the clamping of the threaded body on the tube only.

In order to obtain the unscrewing of the cap, an undercut tool is used to reach the pre-established zone of the threaded body; the tool engaging teeth found on a lower appendix of the threaded body.

The undercut tool is fitted with own teeth shaped to apply an unscrewing couple only and not a screwing one.

The pre-established accessing zone to the threaded body for the unscrewing, engaged by a tool, is located on the upper part of the threaded body and it is reached through a passage in the envelope.

The engaging zone of the external contour of the envelope presents knurls, grooved or polygonal profiles for an efficient transmission of the screwing torque.

A sliding pair is provided, said sliding pair being formed by a radial protuberance and a corresponding groove located in the internal wall of the envelope, the sliding pair allowing the transmission of the torque in both directions between the envelope and a cylindrical member, and allowing the cylindrical member to freely axially translate inside an internal housing located between the threaded body and the envelope.

A spring is further provided to keep the frontal teeth of the axial free tripper engaged.

The axial free tripper comprises teeth integral with the threaded body and teeth integral with the cylindrical member; the shape of the teeth is chosen to allow the transmission of a sufficient screwing couple and a negligible unscrewing couple between the envelope and the threaded body.

The radial free tripper comprises teeth integral with the threaded body and radially deforming teeth integral with the envelope; the shape of the teeth is chosen to allow the transmission of a sufficient screwing couple and a negligible unscrewing couple between the envelope and the threaded body.

The contact between teeth, integral with the threaded body and teeth, integral with the envelope, occurs on contact surfaces inclining of an angle (γ, δ) in order to disengage the contact between teeth and teeth, so that the screwing couple transmitted by the envelope to the body is limited.

### AIMS AND EMBODIMENTS OF THE INVENTION

In order to modify the gas quantity inside the tire, a valve is usually fixed on the tread of the wheel (in case of tires with tube, the valve is sealing fixed to the same tube and comes out from the tread through a hole).

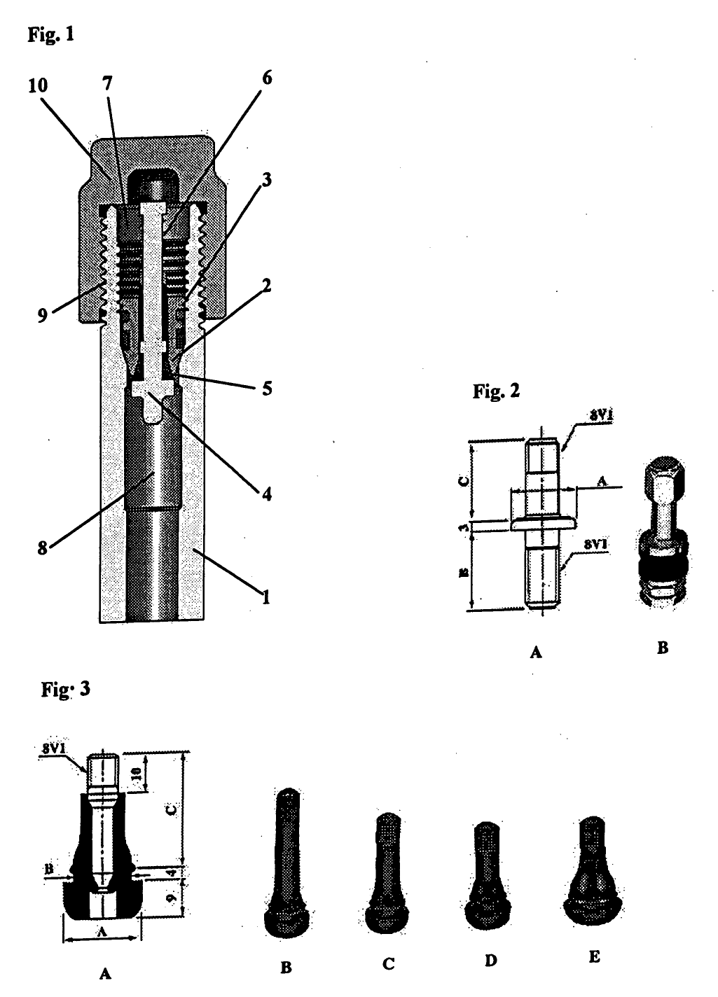

Said valve, shown in FIG. 1, substantially consists of a metal tube 1 containing a body 2 fixed to its inner part through a sealing threaded connection 3, in which a self-closing member 4 with a sealing gasket 5 axially slides, said closing member 4 being hold in the closing position by a spring 6. The closing member 4 is capable of automatically opening when the pressure in its part faced outside, that is in the chamber 7, multiplied for the efficient surface of the sealing gasket 5 generates, on the closing member 4, an axial downwards force higher than the one due to the pressure in its part faced inside, that is in the chamber 8, or inside the tire, multiplied for the efficient surface of the sealing gasket 5 further to the force of the spring 6 or, vice-versa, capable of remaining closed when the force due to the pressure in its part faced outside (chamber 7) is lower than the one due to the pressure inside the tire (chamber 8) further to the force of the spring 6. Of course, the self-closing member 4 is also opened by a mechanical action from outside by applying a force on its end pushing towards the internal part of member 4 (this is an easy procedure to be followed by everyone to make the air come out from the tire).

For what concerns the fixing of the valve to the wheel group, that is to the tread, in case of a tire with the tube, the metal tube 1 is let into a rubber protuberance connected to a hole in the tube of the tire, this protuberance being then inserted in its own hole in the tread; on the contrary, in case of tubeless tires, the metal tube 1 is properly shaped and eventually threaded, as shown in FIG. 2, in its lower part in order to get a direct connection, by interposing proper gaskets, to the hole of the wheel tread (not shown) allowing the fixing through the clamping of a nut (full metal valve), which is connected to the hole of the tread by the simple interference of a rubber covering (FIG. 3) applied to the metal tube 1 and then properly shaped and fitted with a groove having a suitable diameter (B), and with an abutment of diameter (A) capable of assuring the fixing of the valve loaded by the gas pressure inside the tire. All these embodiments are known and standard and the valves are obtained according to the different kinds of length and diameter.

The end of the metal tube 1 faced outside is externally threaded (member 9 of FIG. 1) both to allow the clamping of members for inflating the tire and to grant the screwing and the clamping of a device 10 closing and/or protecting the valve or another device presenting further aims depending on the functioning condition of the tire, which will be, here following, called “cap”, capable of preventing the direct entrance to the sealing internal part of the self-closing member 4, and protecting said member 4 and the relevant gaskets from impacts and/or the introduction of polluting external means (dirt, dust, etc) causing damages or malfunctioning.

The main aim of the cap is to protect the valve and its internal components against unexpected external means (dirt, etc), anyway, nowadays; several kinds of caps are available in order to assure more functions with different levels further to the usual protection against dirt and gas leaks.

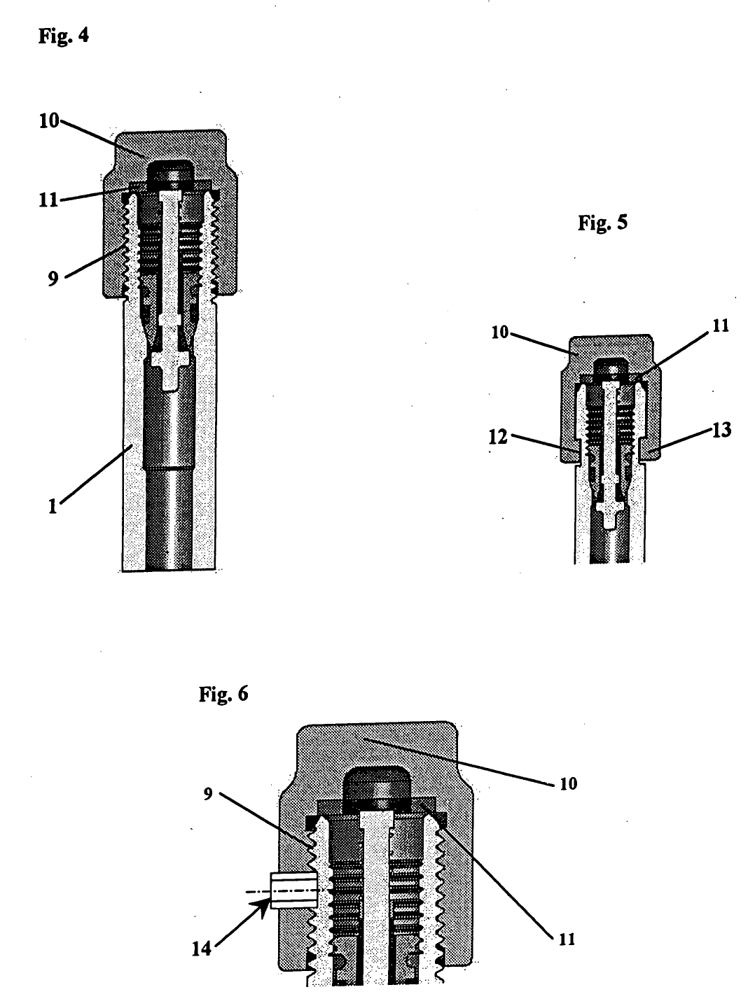

Caps with gaskets for clamping the end of the metal tube are known, see the member 11 of FIG. 4, capable of sealing against any gas leak through the valve when its internal members 3, 4, 5 of FIG. 1 cannot assure a perfect sealing.

If the cap, for its particular shapes, proposes technologic members, and/or consists of special materials, and/or specially coloured, intensifies real or supposed technologic features (of the cap, wheel and/or its components, vehicle, etc) it meets aesthetic functions. In addition, the cap is capable of supplying particular information about, for example, the tire and its use: for example, the colour of the cap often indicates the inflating with gas different from the usual air (for example, nitrogen, helium, etc) and/or specifies the safety function of the cap (for example, the yellow colour of the caps of the valves used for the tires of the aircraft).

Finally, caps are known including also measuring and/or surveying groups for the functioning condition of the tires (for example, by means of the measuring of the inflating pressure, temperature, etc.) and/or groups signalling the functioning condition outside. For example, the cap disclosed in EP No. 0 893 284 belonging to the Applicant. In these cases, said groups protect like a cap.

Here following, as “cap” will be called any member capable of being applied at the end of a tire inflating valve carrying out one ore more functions, some of these having been mentioned above.

Of course, the caps, as above defined, have to assure the mounting on the valve and the dismounting from the same valve (for example for the usual tire inflating) for many times. In addition, it is necessary to consider that many typologies of groups for surveying and/or controlling and/or signalling the functioning condition of the tires have been developed. Some of these groups are clamped with the part of the valve located inside the tread; in this case the part of the valve located outside the tread usually maintains the shape and the dimension of a standard valve. Other groups are directly fixed to the internal part of the tread, and, therefore, the tire-inflating valve is not involved. In any case, the external end of the tire inflating valve is still protected by a cap screwed as in the usual inflating valves. All the systems known from the prior art, both for usual inflating valves for tires with usual protection caps, and for special valves containing devices for surveying and/or controlling and/or signalling the functioning condition of the tires, and for usual valves in which, instead of the usual protection cap, a device for surveying and/or controlling and/or signalling the functioning condition of the tires is screwed at the ends of the valve, do not provide any appropriate mean to prevent the usual unscrewing of the part screwed to the external end of the valve (either for an usual cap or a more composite group for surveying and/or controlling and/or signalling the functioning condition of the tires). Therefore, said part is screwed to the valve (by hand or by proper tools) and, consequently, is easily unscrewed (by hand or by said tools). On the wheels of the land and aircraft vehicles with tires, anti-sabotage and an anti-theft function is expected. The anti-theft function can be considered as a subset, or a consequence, of the anti-sabotage function, in particular when the cap consists of a more complex device capable of carrying out other functions (for example, surveying and/or signalling the functioning condition of the tire) and/or, anyway, fitted with an own sensible value.

The known tire inflating valves have a cap which, if it does not carry out other functions for surveying and/or controlling and/or signalling the functioning condition of the tires, generally protects the internal part of the valve, being used also, if it is fitted with a proper gasket 11, as further sealing against gas leak through its inflating valve.

The cap 10, usually consisting of polymeric or metallic material, fitted or not with a sealing gasket for the tire inflating valve, is screwed on the threaded end of the valve, usually by hand, and, therefore, it is always easily unscrewed by hand. Also in case of more improved caps, eventually made of more resistant materials (for example metal substances) and screwed on the valve through stronger clamping couples obtained by means of proper manoeuvring keys or tools (pincers, for example), the removing of the cap is easier.

Everyone can unduly remove the cap without particular ability and/or proper tools in few seconds, in order to easily access to the valve and to its internal components (and, through them, inside the tire) and/or to appropriate the cap.

Both in case of usual protecting caps of the tire valves and in case of more complicated devices applied on the valves instead of the usual protecting cap, the theft does not cause the loss of an economical value only (that is very cheap in case of usual protecting cap) and the possible end of the functions the stolen cap carried out (in particular the devices for surveying and/or controlling and/or the signalling the function condition of the tires used instead of the usual cap), but, above all, the loss of the cap causes the risk of contamination and possible dangerous external actions for the valve body, and in particular for the self-closing member 4. In any case, the theft causes inconvenience, trouble, and annoyance for the owner and/or driver of the vehicle. Therefore, the anti-theft function for these devices is suggested both for usual protecting caps of the tire valves and for a device signalling the tire inflating condition.

In addition to the above matter, the main problem of tampering or of the real sabotage is connected, since the removal of the protecting cap of the valve (for any kind of it) is often carried out not only to take possession of the cap, but also to access to the self-closing member 4 acting the opening of the valve and allowing the leakage of gas from the tire. Further to more evident actions, one of the classic case can occur (and that often occurs, in fun, from spite or for other worse reasons, up to a real attempt to the health of the driver and the passengers of the vehicle) is the intentional total or partial deflating by someone, of one or more tires (that probably being the case more easily and quickly to be obtained and, also, the worst one. In fact, it is very difficult to see a partial and unexpected deflating when getting in a vehicle or driving it at low speed, but the consequence can be even fatal because of the worsening of the driving and safety conditions for the vehicle, above all in case of high speed).

In order to obtain the partial or total deflating of the tire without particular effort, without using tools, without evident actions, that is without risks and in a short time, it is sufficient to remove (temporally or definitely) the protecting cap of the tire valve and to manually and directly act on the self-closing member 4 housed inside the tire inflating valve: pushing it with a soft effort towards the inside of the valve, the self-closing member 4 opens and allows the leakage of gas from the tire. Apart from the purpose of this action, it is a sabotage, which can have more or less serious consequences, from the only annoyance to the disaster. The matter is rather important in an age when, because of the political, religious, social, racial etc. reasons, the risk of attempts to particular subjects or, also, for terrorist purpose (therefore, without an exact choice of the person to be hit) it is increased, as the daily news disclose. The chance, so doing, to cause serious damages with a real cheap cost and a negligible risk cannot be undervalued (consider a sabotage of the tires of a bus), so that such a device being available for all the vehicles becomes very important. This kind of sabotage so easily practicable could be prevented, or, at least, could take a long time, or could be difficult and risky to be carried out, if it should be impossible to unscrew by hand the protecting cap of the tire valve. This behaviour of the valve would also carry out the secondary anti-theft function as above disclosed.

It is, therefore, useful and important to prevent such a situation. To obtain the desired results it should be sufficient to prevent the removing of the cap 10 (both for usual protecting cap or a device with other functions, as, for example, for controlling and/or signalling the functioning and/or using condition of the tire) without using a particular key or a tool available for staff only authorised to access to the valve or, anyway, to remove the cap.

### AIMS AND FEATURES OF THE INVENTION

The aim of the invention is to remedy to the failure of the prior art. The invention, as claimed, solves the problem of creating an anti-sabotage and anti-theft device for tire inflating valves.

The solved problems and the main features of the invention are disclosed below by referring to the enclosed drawings, not limiting the purpose of the invention:
1. To prevent the undue or unwanted removing of the cap 10 that means, practically, to provide the cap with the desired anti-sabotage function and, consequently, with the desired anti-theft function of the cap, without modifying the structure of the valve and the usual montage and use of the cap formalities;
2. To provide the cap with a device for controlling of the clamping torque.

As shown in FIGS. 5, 6, the anti-sabotage device is obtained in several ways, for example, by locating on the end of the valve, as interference for the connection of the cap, an undercut shaped contour 12 (See FIG. 5), instead of the usual threading 9 so that the clamping cap 10 radially embraces one of its parts 13 around the undercut shaped contour 12; or, by keeping the threading 9, to provide (FIG. 6) the cap 10 with a further radial clamping device 14 with respect to the end of the valve (clamp, radial screw, etc.) requiring a particular tool to be acted for removing the cap 10.

It is necessary to consider that it is not suggested to modify the usual tire inflating valve and, therefore, it is better to maintain the threaded end (standard) unchanged even providing the valve/cap group with an anti-sabotage-anti-theft device. It is also suggested to avoid using systems capable of changing or modifying the threaded end and, in general, the standard original structure of the valve.

It is also preferable, for practical reasons, that the montage and the clamping of the cap 10 (also in case of a more complex system and carrying out one or more functions, with particular regard to functions for controlling and signalling the functioning condition of the tire) and the starting of the anti-sabotage-anti-theft function are as normally obtained as for the screwing and clamping of the usual protecting cap, by hand, without particular tools or keys, since the anti-sabotage and anti-theft functions are useful only to prevent the removing of the cap, while they cause a difficult montage phase of the cap on the valve.

To attain the anti-sabotage and anti-theft functions without modifying the usual montage and clamping formalities of the cap 10 and without changing, anyway, the usual standard inflating valve of the tire, that is by maintaining the connection through the threading, it is necessary to provide the cap with apparatuses prevent the removing by just unscrewing unless a particular key or tool, to be supplied and not available for everyone, is used. This is the aim of the invention. The solution cannot, of course, be so obvious: therefore, it cannot, for example, base on a very strong final clamping of the cap 10 during the montage for the screwing, that can prevent the unscrewing without using the keys or pincers allowing to apply quite high unscrewing couples on the cap 10.

In fact, everyone can be easily provided with these generic tools or members with equivalent function, and, therefore, it should not necessary, in this case, any particular tool or key for authorised staff only. Substantially, the function cannot be easily associated to a higher torque to be applied to the final clamping of the cap 10 after the screwing on the valve body.

In the same way, the function cannot be reached through a device which, when it is screwed on the valve, requires the permanent changing or the destruction of the device (to be carried out by means of particular tools) to obtain its removing, since it avoids the main need to use again the cap 10 for several times.

On the contrary, it is important that the cap 10 is normally screwed by applying the proper torque to the envelope 16 (usually this operation is carried out by hand, therefore the torque never results very high because of, also, the small diameters of the envelope), but that, when the clamping is reached, the threaded connecting member is no more removable if a particular tool, or mechanism or key is not used.

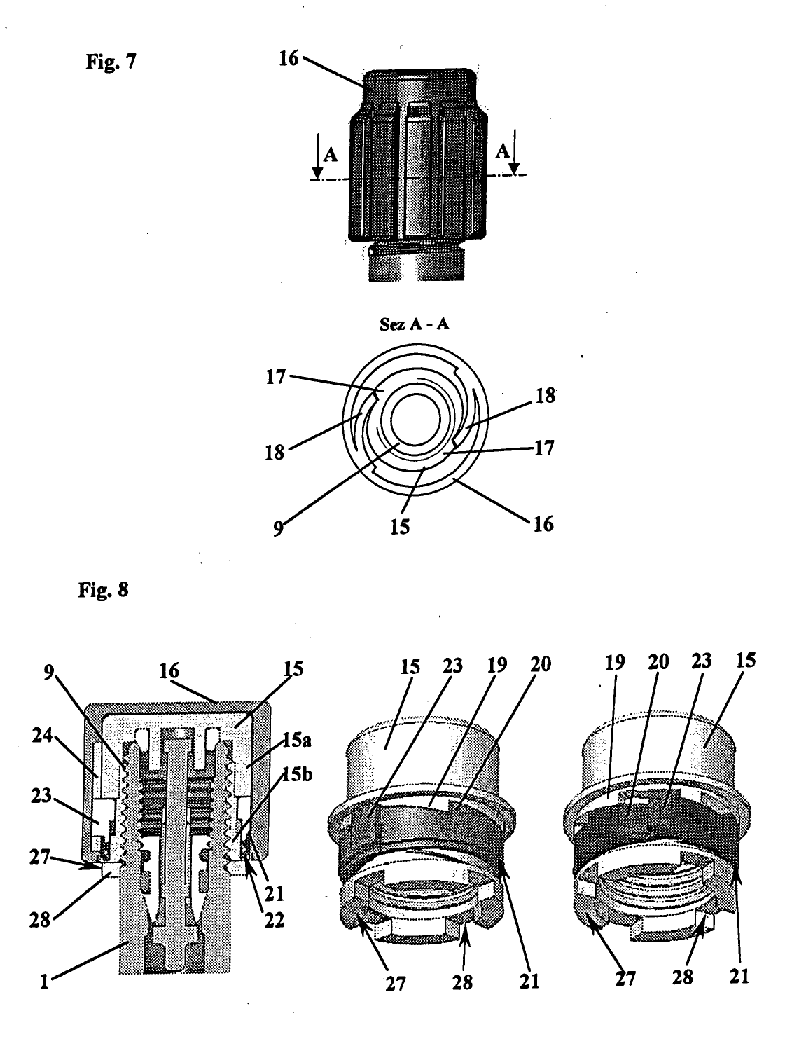

A formality to reach what is desired is obtained through a cap 10 that is no more a single part (now, the usual caps have an envelope which is directly threaded inside for the clamping to the end of the valve) but it is fitted with, at least, the two main members of FIG. 7: an internally threaded member 15 capable of screwing on the end of the valve 9 and the envelope 16 of the cap. The connection between the envelope 16, the clamping and screwing couple is applied to (for example by hand by a proper tool) and the internally threaded member 15 is reached though a free tripper (FIG. 7 section A-A) allowing the transmission of a torque between the envelope 16 and the threaded body 15 in the screwing direction only. So doing, when the clamping of the cap is reached and a proper stopping torque is granted (capable of contrasting an unscrewing couple), it is impossible to unscrew the cap from the valve since the unscrewing couple applied to the envelope 16 is not transmitted to the threaded body 15.

In order to remove the cap 10 it is necessary to provide parts on the threaded body 15; said parts being properly shaped and capable of clamping by means of a special key, or tool, or similar mechanism to be supply and available for staff only charged to remove the cap 10. Suitably, said parts are located in a zone of the cap/valve group not directly accessible, so that the unscrewing by means of improper tools instead of specific tools is prevented.

In addition, not only a device for surveying and/or controlling and/or signalling the functioning condition of the tires mounted in place of the protecting cap of the valve, but also the current protecting caps of the valve need a full and sure clamping on the threading 9 of the tube of the tire inflating valve. This clamping is necessary not only to avoid their unscrewing and falling during the running of the vehicle because of the external forces and vibrations, but also to assure the efficiency of one of the functions that these components (also in case of current protecting caps) have to carry out, consisting of creating, through a gasket 11, a further barrier to the eventual gas leakage through the valve when the self-closing member 4 or other internal parts of the inflating valve cannot assure a proper sealing for the gas of the tire and, therefore, cause a leakage through the internal passage of the valve.

The function preventing the manual unscrewing of the cap 10 after its screwing on the tire inflating valve is obtained by separating the envelope 16, capable of being manipulated and used to transmit to the device the couple necessary for the screwing, from the internally threaded member 15, capable of screwing on the threaded end of the tube of the tire inflating valve, and by introducing between them an unidirectional free tripper.

Said unidirectional free tripper has a radial shape according to the functioning schemes of FIG. 7 Section A-A, or an axial shape, according to the functioning schemes of FIG. 8.

According to a preferred embodiment of the radial shape, radial teeth 17 are found on the external cylindrical surface of the threaded body 15, the teeth 17 being capable of engaging the frontal surface of proper protuberances 18 connected to the internal cylindrical surface of the envelope 16. Said protuberances 18 are normally located in the configuration of FIG. 7 Section A-A, but they present elasticity sufficient to allow their radial flexion towards outside so that they disengage, eventually, from the teeth 17.

The radial elasticity of the protuberances 18 is eventually controlled or changed by means of external elastic members, as springs, polymeric members, etc.

By applying a torque in a clockwise direction (according to FIG. 7 Section A-A) to the envelope 16, the protuberances 18 engage the teeth 17 and transmit the torque to the threaded body 15. Vice-versa, by applying a torque in a counter-clockwise direction (according to FIG. 7 Section A-A) to the envelope 16, the protuberances 18 slide on the back of the teeth 17 and they do not transmit any torque to the threaded body 15 (a minimum value due to the friction during the sliding of the protuberances 18 on the back of the teeth 17 excepted).

According to a preferred embodiment of the axial scheme as for FIG. 8 of the frontal teeth 19, parallel to the axis of the device and located on an external circumference of the threaded body 15, engage the homologous axial frontal teeth 20 located on a cylindrical member 21 to be co-axially mounted on the threaded body 15 and capable of axially sliding downwards with respect to the body 15. The sliding has a sufficient width to disengage the homologous teeth, while a spring 22 pushes on the cylindrical member 21 upwards, which tends to maintain the teeth 19, 20 in contact each other. For mounting reasons of the cylindrical member 21, the threaded body 15 consists of two parts 15a, 15b welded each other.

The cylindrical member 21 is connected through a sliding pair, for example the radial protuberance 23, to a corresponding groove 24 located in the internal wall of the envelope 16; so doing, it is possible to transmit a torque in both directions between the envelope 16 and the cylindrical member 21, which, anyway, carries out its axial translation in the housing located inside the external cylindrical surface of the threaded body 15 by contrasting the action of the spring 22.

By applying a torque in the screwing direction on the envelope 16 said torque is transmitted to the cylindrical member 21, its axial teeth 20 engage the homologous axial teeth 19 of the threaded body 15. In this way, the stopping torque is transmitted to the threaded body 15.

After the clamping, a non-return couple acts between the threaded body 15 and the threaded end 9 of the tube 1 of the tire-inflating valve.

By acting a torque in the unscrewing direction on the envelope 16, said torque is transmitted to the cylindrical member 21, its axial teeth 20 tend to slide on the homologous back of the axial teeth 19 of the threaded body 15; this is due to the particular inclination angle of the backs of the teeth, so that the cylindrical member 21 tends to downwards translate against the force of the spring 22, without transmitting an unscrewing couple to the threaded body 15, a value of the friction couple in the sliding motion of the backs of the axial teeth excepted.

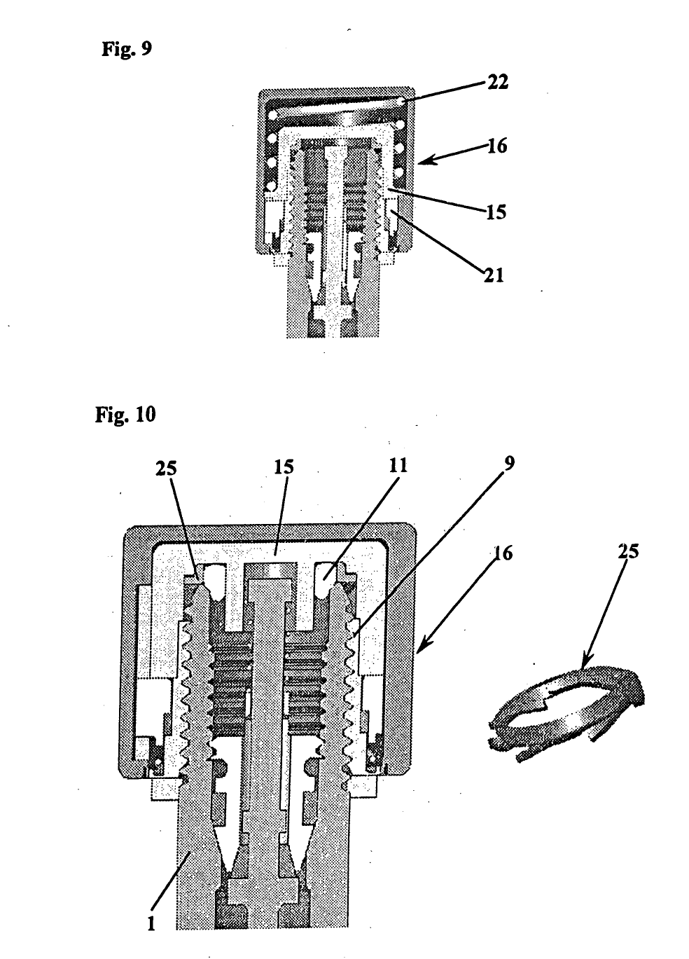

The spring 22, as shown in FIG. 9, is also located between the threaded body 15 and the envelope 16: in this case, said spring 22 acts as above, if the sliding pair between the envelope 16 and the cylindrical member 21 presents an axial abutment compelling the cylindrical member 21 to move downwards the envelope 16 against the force of the spring 22, if the unscrewing couple is applied to the envelope 16 and the teeth backs of the cylindrical member 21 slide with respect to the ones of the threaded body 15.

With this configuration, it is also possible to make the envelope 16 and the cylindrical member 21 in just one piece or make them integral each other.

The embodiment with radial arrangement presents a radial encumbrance higher than the axial arrangement: therefore, this axial arrangement is better than the radial one because of the limits for the radial admissible encumbrance with respect to the environment and the components existing around the tire inflating valve.

It is obvious that, by using these kinds of mechanisms, only a part of the torque in the screwing direction (in a clockwise direction in FIG. 7 if a right thread is used) is transmitted to the threaded body 15 because of the friction between the free tripper teeth and the threaded body 15.

In both radial and axial embodiments, the mesh among the homologous teeth is replaced by homologous cavities on both parts with interposition of properly shaped floating connecting rods, as for free trippers of common industrial production.

So doing, the unscrewing of the device acting on the external envelope 16 is prevented, as it is desired, on condition that the threaded body 15 is clamped if it is screwed, causing a non-return clamping couple with a value higher than the torque that can be transmitted in the unscrewing direction, said torque being low but existing.

In order to assure a higher non-return clamping couple, further to the usual friction between both parts connected through the thread when their both ends are in contact, other technical members are used, as for example:
Self-clamping devices in the threaded body 15 on the male thread 9, as a partial deformation of the female thread of the threaded body 15 or the interposition, on its upper end, of a deforming element capable of causing an high friction couple on the thread 9, as usually used for the self-clamping nuts. (See Filippi, Disegno di Macchine, Vol. II, Hoepli as known not limiting or exhaustive examples);
Further components allowing a strong friction and an effective non-return couple between both parts 15, 19 fixed each other, as for example elastic washers of UNI 1751 e 1752 o DIN 128, undulated and knurled elastic washers, plane or conic elastic washers with toothing according to UNI 3703, 3704, 3705, 3706, etc (See Filippi as cited), to be applied to the abutment end of the male thread 9 in order to avoid damages of the male thread.

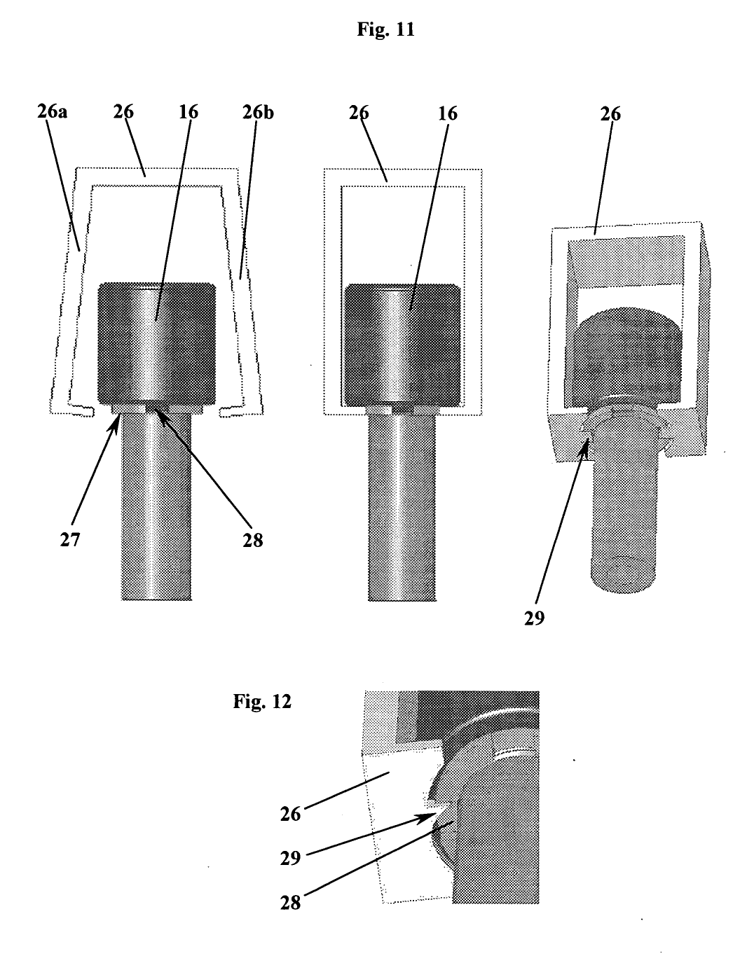

An embodiment is shown in FIG. 10: the upper abutment end of the male thread section 9 of the tube 1 of the inflating valve contemporaneously touches both the sealing gasket 11 and the element 25 characterised by elastic axial toothings engagingthe seat found on the upper end of the cavity of the threaded body 15 and the abutment end of the tube during the clamping, causing a strong non-return couple against the unscrewing.

To assure the unscrewing is carried out when required, without carrying out by hand or by usual tools and/or commercial members, it is necessary to apply the unscrewing couple directly on the threaded body 15 in zones which are reachable only by means of proper tools and available only for buyer of components fitted with anti-theft devices.

An embodiment is shown in FIG. 8, 11, this embodiment using a special key 26 with two arms on the lower part 27 of the threaded body 15; the key 26 axially extended downwards so that proper radial notches 28, capable of introducing the teeth 29 of the special key 26, are formed. Said lower part 27 is covered by the external envelope 16 and is undercut with respect to the envelope 16 if someone wants to access from outside (considering the usual mounting condition of the tire valves on the vehicle wheels). Only by means of a key capable of conforming to the undercut and engaging the notches 28 found on the lower part 27 of the threaded body 15, so that the required unscrewing couple is applied to the threaded body 15, the unscrewing of the valve cap is carried out.

Both arms 26a, 26b of the special key 26 are flexible or movable in the radial direction to open and allow reaching the lower part 27 of the threaded body 15.

The teeth 29 located at the ends of the arms 26a, 26b of the special key 26 to engage the lower part 27 of the threaded body 15 are shaped as shown in FIG. 12 in order to be used just for applying a unscrewing couple to the threaded body 15, said teeth 29 present a sloping plane tending to extract them from the notch 28 if a screwing couple is applied. This is useful to avoid, anyway, the application of exceeding clamping couples.

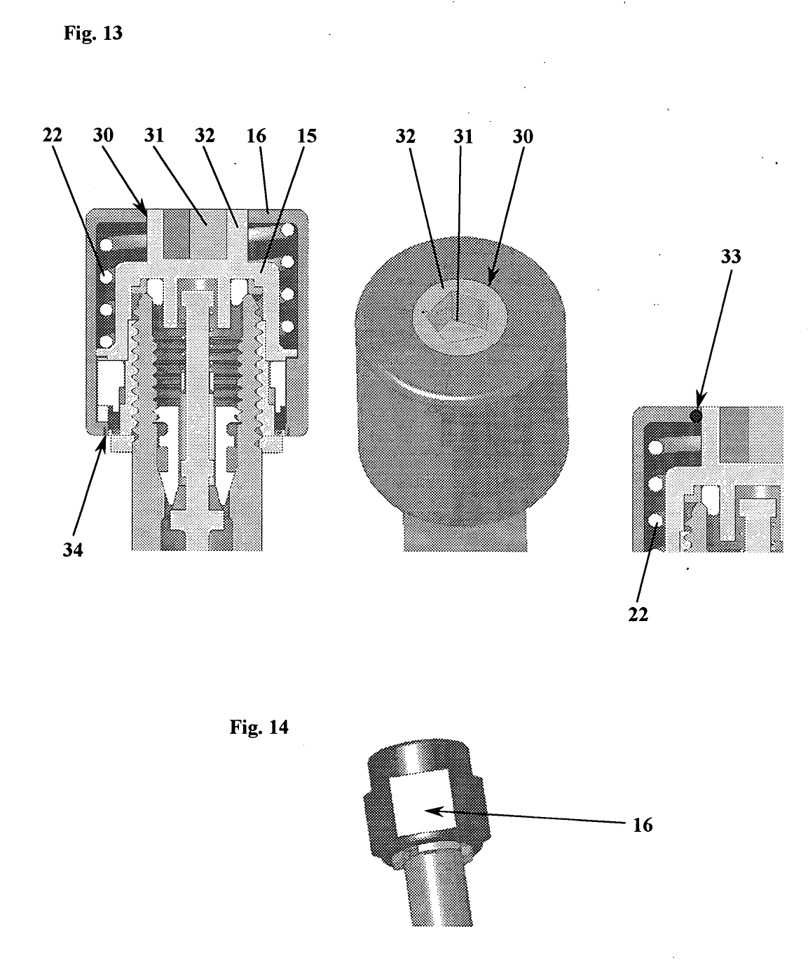

A further embodiment to directly apply the unscrewing couple to the threaded body 15 in zones which are reached only by means of proper special tools consists, as shown in FIG. 13, of creating a central opening 30 in the upper wall of the external envelope 16, through said central opening 30 a blind hole 31, finding on a protuberance 32 located on the upper part of the threaded body 15, is reached. The protuberance has a proper and non standard contour where only a key with a male profile having the same area of the blind hole 31 is inserted for unscrewing.

To prevent the introduction of impurities, the interference zone between the central opening 30 of the envelope 16 and the protuberance 32 is fitted with a proper gasket 33.

In all the described embodiments, in order to prevent the introduction of impurities, a further gasket or protecting lip 34 is provided in the lower part of the envelope 16 in its interface zone with the cylindrical lower part of the threaded body 15.

In all the above mentioned embodiments, it is also possible to shape the external contour of the envelope 16 in the engaging zone for applying the couple (both manual and by means knurls, grooved or polygonal contours as shown in FIG. 14.

The clamping of the cap on the valve is correctly reached when it is obtained by means of a proper, sufficient and not excessive final couple. Both in case of manual screwing of the cap on the end of the tire inflating valve and, above all, in case of using of ancillary tools for a stronger clamping couple, the risk is to apply a too strong clamping couple damaging the cap and/or the sealing gasket 11. But, the application of an excessive clamping couple is not the only problem: also an insufficient clamping couple is harmful since it invalidates the sealing gasket 11 action and causes the unexpected, even full, unscrewing of the cap because of the vibrations due to the running of the vehicle.

Advantageously, the anti-sabotage and anti-theft device applied to the protecting cap of the tire valve (also in case the cap comprises groups for surveying and/or controlling and/or signalling the functioning condition of the tires) is, therefore, fitted with members assuring an efficient and full clamping of the threaded elements 15, 9 and of the eventual gasket 11 located inside the cap for sealing on the upper edge of the threaded end 9 of the tire inflating valve by a not skilled person who has not any proper tool (and, therefore, he is not able to verify if the couple for the screwing has a sufficient value for clamping).

Another embodiment is suggested which, further to assure a full and efficient clamping of the threaded body 15 on the valve 9, that is to advise the operator when a screwing torque with a proper value is reached, prevents an excessive clamping by applying screwing torque with a value higher than the proper one. In fact, the excessive clamping causes, as known, a quick deterioration of the component and/or its destruction and consequent uselessness when protection caps for tire inflating valves made of plastic are used. That particularly occurs when the cap presents a gasket in the beat zone for sealing of the tire gas. An excessive clamping torque easily damages this gasket. Of course, this occurs also in case of a component screwed on the end of the valve carrying out other functions, as for example surveying and/or controlling and/or signalling the functioning condition of the tire, not only in case of an usual protection cap.

To reach this purpose it is necessary, therefore, to apply a limiting device for the screwing torque also capable of advising the operator if the required torque value is obtained. The usual and well-known tire valves, and relevant protection caps, do not present any function or any anti-theft and anti-sabotage device, nor mechanisms assuring a full and efficient clamping of the cap and its sealing gasket on the threaded end of the tire inflating valve. The same thing is valid for the device surveying and/or controlling and/or signalling the functioning condition of the well-known tires.

A device to get what mentioned above consists in applying a member limiting the screwing torque applied by the external envelope 16 to the threaded body 15 through the free tripper.

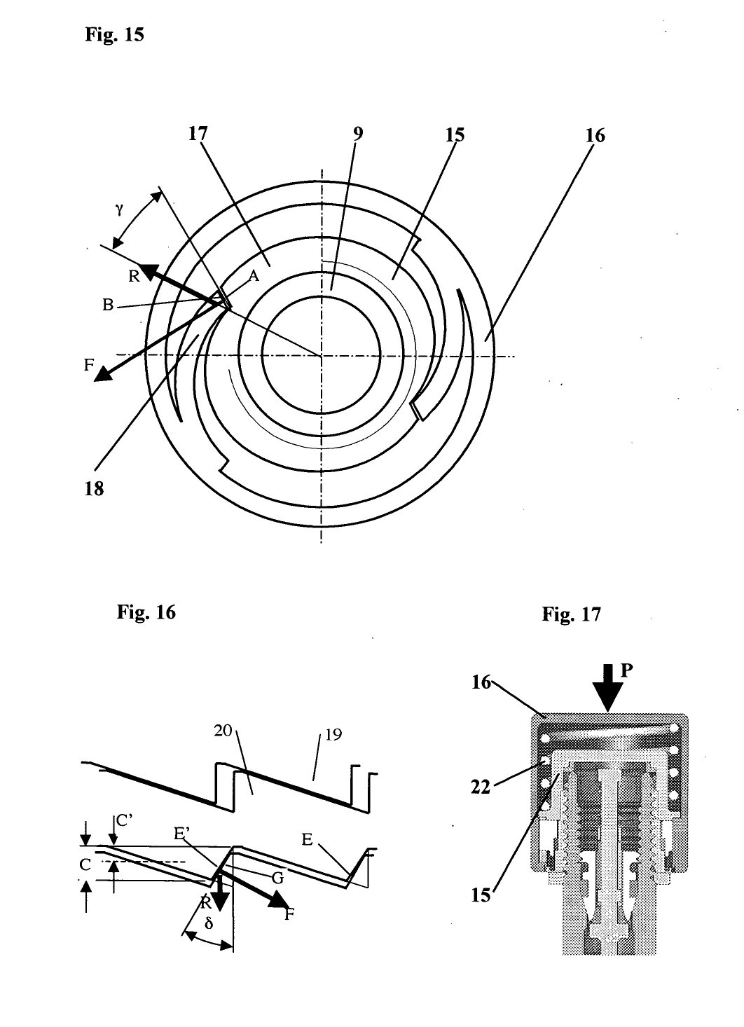

Considering the radial free tripper with teeth integral with pieces of FIG. 7 Section A-A shown in FIG. 15, the frontal part located between the teeth 17 and the protuberances 18 is so shaped that the frontal part is not radial, that is perpendicular to the force mutually transmitted each others (approximately tangential), but slanted with a proper angle γ with respect to the radial direction causing, during the contact between both surfaces A and B of the tooth 17 and the protuberance 18, a radial component R tending to bend the protuberance 18 towards outside in order to disengage it from the corresponding tooth on the threaded body 15.

When a pre-established perpendicular force F between the two surfaces A and B (that is when a pre-established torque value applied to the external envelope 16 is reached assuring the proper clamping of the threaded body 15 on the tube of the tire inflating valve), the radial component R reaches a value causing the disengaging of the two surfaces A and B of the teeth of the free tripper. This, as desired, limits the maximum clamping couple to be applied and advises the operator, who is applying the torque, that a quick decrease of the opposite couple, together with a vibration and noise due to the radial release of the teeth, by indicating the correct conclusion of the clamping operation. So doing a first kind of radial free tripper is reached, also forming a couple limiting device which is easily regulated by properly planing the angle γ and the elastic reaction of the protuberances 18.

With regards to the axial free tripper embodiment as shown in FIG. 8, the couple limiting device is made by a slant δ of FIG. 16 to the contacting surfaces of the frontal teeth 19, 20, initially on planes parallel to the axis of the device, transmitting the torque between the external envelope 16 and the threaded body 15 through the cylindrical member 21: the same effect as described above for the radial free tripper is reached. So doing, moreover, frontal cams 19, 20 are obtained allowing a relative helical movement between the external envelope 16 and the threaded body 15. By using a contrasting elastic member (the spring 22 of FIG. 9), properly loaded, tending, as reaction, to prevent the axial movement of the cylindrical member 21 and/or the external envelope 16 with respect to the threaded body 15, said helical movement, and the relevant axial descent of the cylindrical member 21 and/or the external envelope 16 with respect to the threaded body 15, begins only after the screwing couple applied to the external envelope 16 has exceeded a value capable of generating, in the helical coupling of the frontal cams 19, 20, an axial force higher than the one due to the contrasting elastic member 22. When this couple value has been exceeded (corresponding to the correct clamping couple of the two threaded elements) the relative sliding of the helical surfaces E and G of the frontal cams 19, 20 and the descent, for a stroke C, of the cylindrical member 21 and/or the external envelope 16 with respect to the threaded body 15, at the end of which the cylindrical member 21 and/or the external envelope 16, due to the force of the contrasting elastic element 22, releases again upwards until the surface G of the connected frontal cam is in contact with the surface E′ of the immediately following tooth located on the threaded body 15. In this way a second kind of axial free tripper is obtained which, in function of the force of the contrasting elastic element 22, forms a couple limiting device capable of being easily adjusted by properly planing the angle δ and the contrasting force of the spring 22, and, as for the previous case, a system advising that the correct couple value has been reached.

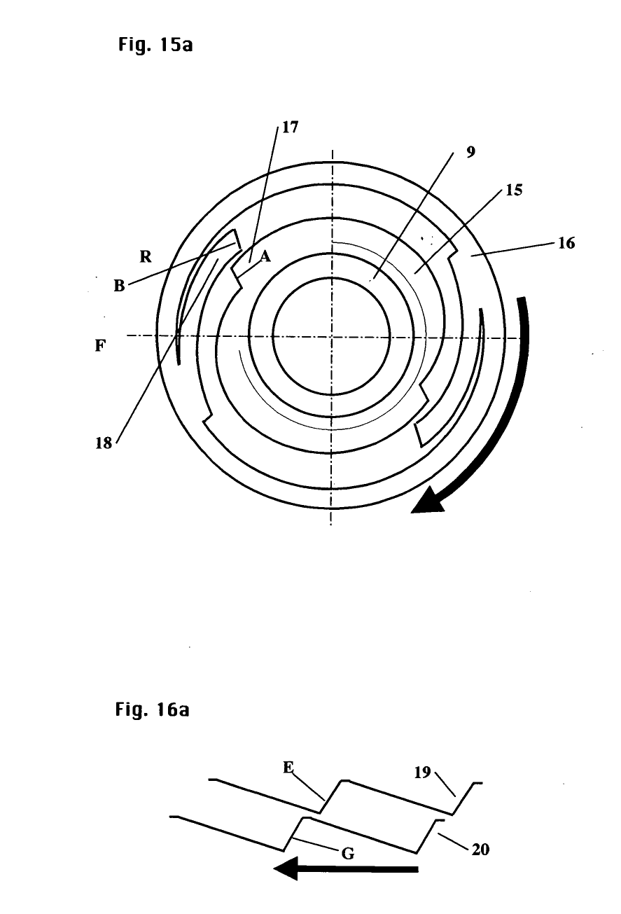

By applying a couple to the external envelope 16 higher than the one necessary to exceed the maximum torque to be applied to the threaded body 15 and the reaction of the elastic element 22, an axial force P positive in the direction shown in FIG. 17 is reached. This force P with stroke C is due to the helical coupling of the surfaces E and G of the frontal cams and to the external envelope 16 with respect to the threaded body 15 or other interposed or connected members. Said axial force P is used for carrying out functions relevant to the mounting and/or functioning and/or using of both usual protection caps of tire inflating valve and, more particularly, devices for controlling and/or surveying and/or signalling the functioning condition of the tires screwed to the external end of the inflating valve.

A further advantage of this embodiment is due to the fact that, before applying the above mentioned positive axial force P, it is, anyway, necessary to efficiently complete the clamping of the threaded body 15 on the end 9 of the valve by assuring in advance the good result of this function.

What said up to now is useful for all the above mentioned cases, in particular when the axial force P is necessary for carrying out the functions relevant the mounting and/or functioning and/or using of usual protection caps of the tire inflating valve and, more particularly, devices for controlling and/or surveying and/or signalling the functioning condition of the tires screwed to the external end of the inflating valve which, before their activation, have to be correctly clamped on the valve with a pre-established couple value even if the operation is carried out by hand and without any particular tool or measuring and controlling member.

An other embodiment of the couple limiting device provides that the relative sliding between the helical surfaces E and G of the two frontal cams, which are respectively found on the threaded body 15 and the external envelope 16, is limited to just one stroke C′ (FIG. 16) lower than the stroke C causing their disengage and the passage of the surface G from the contact with the surface E to the contact with the surface E′ after passing said stroke C. When the pre-established value of the clamping couple of the threaded body 15 on the valve end is exceeded, a direct helical movement of the external envelope 16 with respect to the threaded body 15 occurs; said movement causes a translation of the external envelope 16 with respect to the threaded body 15 for a quantity corresponding to C′. When the clamping couple applied to the external envelope 16 is releases, it occurs the return of the external envelope 16 to its rest position with respect to the threaded body 15, with sufficiently low angles δ, by means of a retrograde helical motion due to the reaction of the elastic element 22.

By applying the couple-limiting device, with respect to the screwing torque, as further advantage, any exceeding clamping is prevented.

All the above mentioned embodiments are applied not only to the usual protection caps of the tire inflating valves, but also to the devices for controlling and/or surveying and/or signalling the functioning condition of the tires which are screwed on the external end of the inflating valve and, therefore, they protect the valve and are subject to the risk of removal for sabotage and/or theft.

The mentioned technical solutions, for what concerns the control of the clamping couple, and in particular the solutions allowing (through the advise of the start of the tripping) to reach a proper and efficient clamping value and/or solutions allowing, anyway, to avoid the application of exceeding clamping couples, can be applied and used separately and/or contemporaneously by applying the anti-sabotage-anti-theft system making the manual unscrewing impossible by an unscrewing couple applied to the external envelope 16.

All the above mentioned embodiments are used not only for components to be applied to the end of the tire inflating valves but in all cases of controlled clamping of threaded members in order to assure a pre-established value of the clamping couple and/or to avoid the unexpected application of clamping couples presenting a value much higher than the pre-established one and/or to prevent the unscrewing by applying an unscrewing couple to an external envelope 16, even if the screwing or unscrewing couples are applied by hand or by means of keys and/or tools which engage the external envelope 16.

All the above mentioned devices, and the external envelope 16 in particular, are made of polymeric materials or metal ones, fitted with colouring due to the nature or pigmentation of the material or to coating of varnish or other substances. In addition, the external plan contour of the envelope 16 presents a circular section or any other section suitable to favour the transmission of the torque by hand or by means of keys and/or tools. In particular, said external plan contour presents protuberances or a polygonal shape.

1. Anti-sabotage and anti-theft device for inflating valves of the tires, characterised by:
a cap with an internally threaded body screwing on an inflating valve of a tire;
an envelope connected to the internally threaded body through a free tripper allowing the screwing only and not the unscrewing of the cap, the envelope preventing to directly access to the threaded body,
the access occurring only in a pre-established zone of the threaded body, while the unscrewing of the threading body occurring through a tool acting on said zone.

2. Device as in claim 1, wherein the free tripper presents a radial development.

3. Device as in claim 1, wherein the free tripper presents an axial development.

4. Device as in claim 1, wherein an element is provided between the threaded body and the threaded end of the tube of the valve; the element generates an unscrewing couple which is higher than the one due to the clamping of the threaded body on the tube only.

5. Device as in claim 1, wherein, in order to obtain the unscrewing of the cap, an undercut tool is used to reach the pre-established zone of the threaded body; the tool engaging teeth found on a lower appendix of the threaded body.

6. Device as in claim 1, wherein the undercut tool is fitted with own teeth shaped to apply an unscrewing couple only and not a screwing one.

7. Device as in claim 1, wherein the pre-established accessing zone to the threaded body for the unscrewing, engaged by a tool, is located on the upper part of the threaded body and it is reached through a passage in the envelope.

8. Device as in claim 1, wherein the engaging zone of the external contour of the envelope presents knurls grooved or polygonal profiles for an efficient transmission of the screwing torque.

9. Device as in claim 1, wherein a sliding pair is provided, said sliding pair being formed by a radial protuberance and a corresponding groove located in the internal wall of the envelope, the sliding pair allowing the transmission of the torque in both directions between the envelope and a cylindrical member, and allowing the cylindrical member to freely axially translate inside an internal housing located between the threaded body and the envelope.

10. Device as in claim 1, wherein a spring is further provided to keep the frontal teeth of the axial free tripper engaged.

11. Device as in claim 1, wherein the axial free tripper comprises teeth integral with the threaded body and teeth integral with the cylindrical member; the shape of the teeth is chosen to allow the transmission of a sufficient screwing couple and a negligible unscrewing couple between the envelope and the threaded body.

12. Device as in claim 1, wherein the radial free tripper comprises teeth integral with the threaded body and radially deforming teeth integral with the envelope; the shape of the teeth is chosen to allow the transmission of a sufficient screwing couple and a negligible unscrewing couple between the envelope and the threaded body.

13. Device as in claim 1, wherein the contact between teeth, integral with the threaded body and teeth, integral with the envelope, occurs on contact surfaces inclining of an angle (γ, δ) in order to disengage the contact between teeth and teeth, so that the screwing couple transmitted by the envelope to the body is limited.
